(19) United States
(12) Patent Application Publication
(10) Pub. No.: US 2005/0270291 A1
(43) Pub. Date: Dec. 8, 2005

(54) Method and system for creating, modifying, and storing photographic fonts

(76) Inventor: Lorraine Forte, New York, NY (US)

Correspondence Address: Thomas Neyarapally;CHADBOURNE & PARKE LLP, 30 Rockefeller Plaza, New York, NY, 10112, US

(21) Appl. No.: 10/860,720

(22) Filed: Jun. 3, 2004

(51) Int. Cl. G06T 11/00

(52) U.S. Cl. 345/467

(57) ABSTRACT

A method of creation, distribution and storage of photographic fonts. At least one image is perceived containing text. The image is photographed onto a photographic media and transferred to computer memory in digital format. Using software, at least one individual image of a character is isolated from the text. Software is then used to isolate each individual image to give it the same dimensions, and optionally, make other adjustments to the characters. The adjusted individual images are saved as a font to a computer storage media. The resulting photographic fonts, which may be distributed by using computer-readable media or the Internet, among other possible methods of distribution, provide graphic designers and others that use fonts with a new tool to creatively express information.

### BACKGROUND OF THE INVENTION

1. Field of the Invention

The present invention is directed to the creation, refinement, and storage of unique sets of photographic fonts on computer accessible media, where the fonts can be used as an artistic alternative to traditional or computer-generated fonts.

2. Description of the Related Art

The mission of graphic design is to communicate information in an interesting and attention-grabbing manner. Graphic designers most commonly employ fonts and photography as tools in relaying information. Fonts are comprised of a plurality of characters of a common style, such style incorporating characters that are indigenous to the identified font's aesthetic characteristics, giving the characters within a font a consistent appearance. Such aesthetic characters include but are not limited to similarity of size, shape, and thickness. Characters may include, but are not limited to, alphanumeric characters such as the letter “A” or the number “7”, symbols such as the dollar symbol “$” or the percentage sign “%”, and dingbats. Persons of skill in the art will be familiar with dingbat characters, but for the purposes of clarification, dingbat characters include non-alphanumeric characters that carry meaning in certain contexts (for example, the paragraph dingbat: |)

Graphic designers and others that use type in a creative way have previously been limited to traditional fonts and computer-generated fonts. Traditional fonts, such as those that appear in books, have evolved over centuries, but provide extremely limited flexibility in appearance. Computer-generated sets of fonts can provide for increased flexibility in appearance. Computer programs that generate such fonts may allow for adjustment of variables that determine the dimensions, shapes, thicknesses, and overall appearance of fonts. Some computer-generated fonts may even be created by programs that allow for arbitrary complexity to be incorporated into the font characters. However, computer fonts require manipulation of variables that determine the characteristics of the fonts. Despite the aid of computers, this process can be highly time consuming and laborious, as each necessary character must be designed. Such fonts are not available immediately when a user is creatively inspired.

Both traditional and computer-generated fonts may also be made available on CD-ROMs or other computer media so that graphic designers can easily access the font sets. While a person skilled in the art can employ computer programs to generate fonts, these fonts tend to have an overly perfect, machine-made appearance that lacks visual weight and appeal in print or on a computer screen, and may thus lack the ability to fully capture the viewer's attention. Existing fonts do not leverage photography and the unique qualities of photographed material as a method of enhancing the tendency of font characters to grab the viewer's attention.

A need thus exists for fonts that are eye-catching and innovative, but that do not require excessive amounts of time and money to individually create the font characters, or to locate individual font characters and assemble a font from individual font characters. Such fonts, when provided together on one computer storage media such as a CD-ROM, through the Internet, or through other available methods, would provide a much needed compliment to the graphic designers' current tools of traditional and computer-generated fonts and photography.

### SUMMARY OF THE INVENTION

It is an object of the present invention to provide a method for the creation of unique photographic fonts that are located on readily accessible computer media.

In accordance with the invention there is provided a method of creation, modification and storage of unique photographic fonts, said method comprising the steps of:
(a) perceiving at least one image at least partially comprising text;
(b) photographing said image with a photographic device onto a photographic media;
(c) transferring said image from said photographic device to computer memory in digital format;
(d) using software to isolate at least one individual image of a character from said text;
(e) using software to adjust each of said individual images of characters so that each said individual image has the same dimensions as the others; and
(f) saving said adjusted individual images as a font to a computer storage media.

The following additional optional steps may be taken to improve upon the quality of the fonts produced by the invention:
(i) The method described in steps (a)-(f), further comprising the step of using software to separate each of said individual images of characters from a background behind each of said individual images of characters.
(ii) The method described in steps (a)-(f), further comprising the step of using software to orient each of said individual images of characters so that the vertical axes of individual characters contained in said individual images of characters are parallel.
(iii) The method described in steps (a)-(f), further comprising the step of using software to adjust the color, brightness, and contrast of said individual images of characters.
(iv) The method described in steps (a)-(f), further comprising the step of using software to retouch said individual images of characters.

The following additional step may be taken after step (f):
(v) The method described in claim 1, further comprising the step of disseminating of a plurality of said fonts using the Internet.

The following step may be taken in conjunction with steps (a)-(f):
(vi) A method according to step (a), wherein said photographing is carried out using a digital camera.

### APPLICATIONS

The method described in the present invention can be used to create a library of photographic fonts that can be later easily accessed for use by graphic designers and others who wish to incorporate alphanumeric characters, symbol characters, dingbat characters, and any other characters into their work. Optionally, the user will be able to utilize the characters with or without the background from which the characters were taken. Further, the user will be able to avail herself of the unique appearance of font characters derived from photographs, without spending extra time and money to assemble and normalize the characters that she wishes to employ. The fonts created using the method of the present invention will provide the graphic artist with several photographic font options, allowing maximization of creative expression at minimal cost.

These together with other objects and advantages that will be subsequently apparent, reside in the details of construction and operation as more fully hereinafter described and claimed.

### BRIEF DESCRIPTION OF THE DRAWINGS

FIG. 1 depicts a flowchart of one embodiment of the present invention.

FIG. 2 depicts a sample set of fonts derived using the present invention.

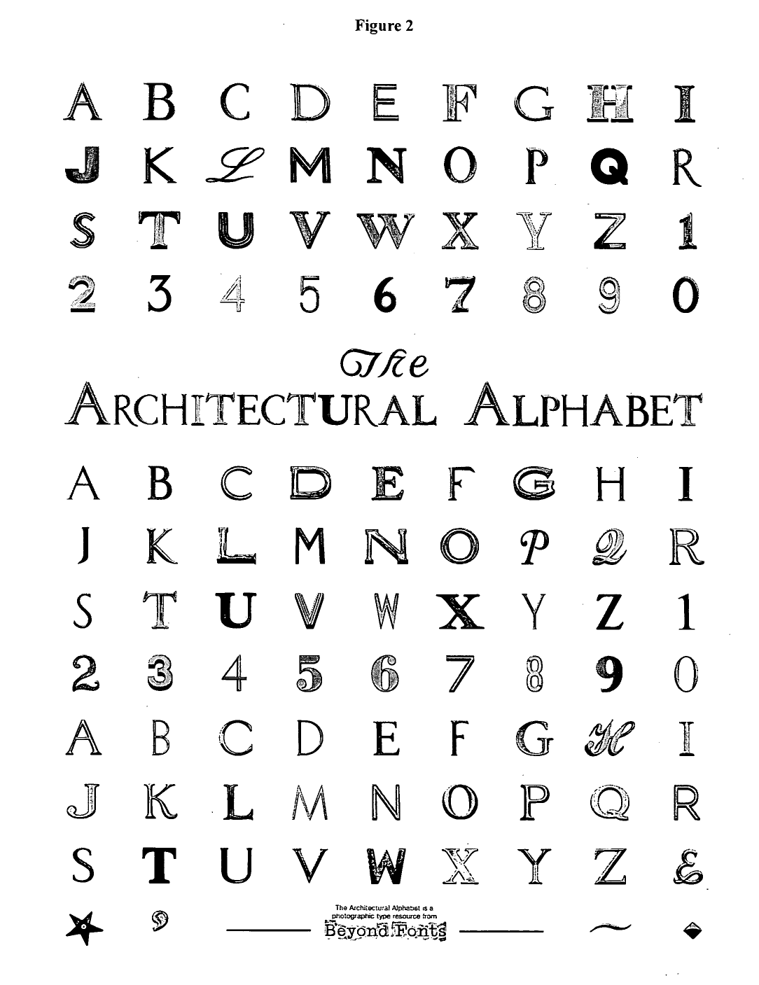

### DESCRIPTION OF ONE OF THE EMBODIMENTS IN ACCORDANCE WITH THE INVENTION

The present invention allows for the transformation of characters located anywhere that the user of the invention can perceive and photograph such characters into photographic fonts. This environment includes, but is not limited to, lettering on objects or objects themselves, and includes but is not limited to buildings. Objects or shapes on objects that form the basic shape of letters or other alphanumeric or other text characters can be used as a basis for a photographic font.

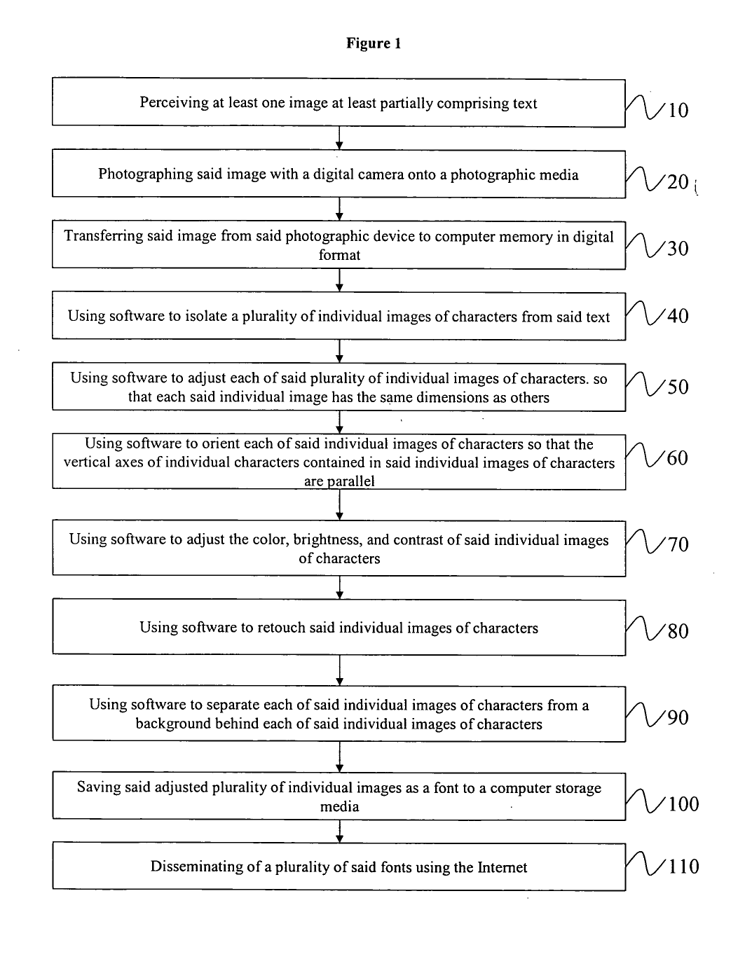

Referring to FIG. 1, objects or shapes on objects that contain or comprise text-like shapes are perceived by the photographer as shown in step 10 of FIG. 1, and photography is then used to capture an image of each of the objects along with its corresponding background in step 20 of FIG. 1. In one embodiment, the objects or shapes on objects share some similar characteristics, rendering them consistent for purposes of creating a font. For example, the photographer might choose characters on taxicabs. In this case, the photographer would take pictures of all letters, numbers, and other characters that the photographer can find on taxicabs. While any type of photography may be used, digital photography provides an easy way to transfer images from camera to computer.

Once the pictures have been taken, the images of the objects and their respective backgrounds must be transferred to a computer to be processed as shown in step 30 of FIG. 1. If the pictures have been taken with a regular camera and film, the film is developed, and the resulting pictures may be scanned into a digital format using a computer scanner or any other methods known in the art to convert film-based pictures into digital pictures. If the pictures have been taken with a digital camera, the pictures may, in one embodiment, be downloaded directly from the digital format contained in the digital camera to a computer using a standard connection between the digital camera and the computer. Such connections include but are not limited to a USB cable or a firewire cable. Those skilled in the art may employ other tools of their choice that are widely known in the art to capture images of font characters and transfer them to a digital format for further processing.

Parts of the invention are carried out using software, including but not limited to Adobe Photoshop, Adobe Illustrator, Macromedia Fireworks, Macromedia Freehand, Corel Draw and JASC Paint Pro.

Once located on the computer, the electronic individual images of characters derived from the film or digital photographs must then be isolated, as shown in step 40 of FIG. 1 and processed to standardize the sizes of the individual images of characters as shown in step 50. This may be achieved using software such as the software named above. In one embodiment, a calibrated monitor is used and the digital files are opened in Adobe Photoshop 7.0 or other software packages used for adjusting image size. The image sizes are then each changed to 300 dpi in dimension without resampling.

Then, in one embodiment, using Adobe Photoshop 7.0 or other software used for aligning individual images, an aligned set of individual images of characters are created as shown in step 60 of FIG. 1. In one embodiment, using Adobe Photoshop 7.0 or other software used for aligning individual images, horizontal and vertical guidelines are dragged onto the individual images of characters. Then, each of the separate individual images of characters is rotated to align each of a plurality of characters contained in the separate individual images of characters. The alignment is achieved by rotating the individual images of characters so that the vertical axes of the characters contained in each image are made parallel to each other. Thus, when the fonts are created, each of the individual images of characters in a font appears to be parallel. In one embodiment, once the individual images of characters are aligned, the Adobe Photoshop 7.0 Cropping Tool or other software used for cropping images is used to select a 300 dpi area surrounding the character contained in the file, and the resized and aligned image is saved into a new native Adobe Photoshop file or other new native file generated from a software package used for cropping images.

The aligned set of individual images of characters is then adjusted for color, brightness and contrast using a standard picture handling program, in order to make the individual characters as consistent in appearance as possible as shown in step 70 of FIG. 1. In one embodiment, tools including but not limited to the Adobe Photoshop 7.0 tools such as Levels, Curves, Color Balance, Brightness/Contrast, Hue, Saturation, Desaturate, Replace Color, and Autocolor, as well as independent software packages for color correction that include but are not limited to iCorrect Professional, are used. Some of the individual images of characters may have small pieces of characters missing or lacking in quality of appearance, rendering the color quality and appearance of the characters inadequate. In one embodiment, these pieces are cloned from another character in the font using tools including but not limited to the Stamp, Copy and Paste, and the Healing Brush tools in Adobe Photoshop or comparable tools included in software packages used to make images consistent in appearance. To rectify any tunnel effects that cause individual characters to appear inconsistent with other images, the Perspective Feature in Adobe Photoshop 7.0 or a comparable tool included in software packages used to make images consistent in appearance is used as shown in step 80 of FIG. 1.

In one embodiment, after the color and brightness of each of the pictures of characters has been adjusted, the characters are then separated from their backgrounds as shown in step 90 of FIG. 1. This can be achieved by a number of methods known in the art. These methods include but are not limited to the use of Bezier rules and the Extraction method achieved by the use of Adobe Photoshop or other software used for the separation of characters from their backgrounds. Those skilled in the art will be familiar with the use of these methods to separate objects from their backgrounds in an image. However, some characters will prove particularly difficult to separate from their backgrounds, rendering trimming or clipping ineffective as separation options. In these cases, the Extraction method will be preferable, as it allows for a more accurately preserved character after separation. When any separation techniques are applied by someone skilled in the art, the result will be a character separated from the image of a character that accompanied it in the original picture.

After creating both an aligned set of pictures of characters with backgrounds, and an aligned set of individual images of characters using the aforementioned methods, the result is a font of a particular style characterized by the appearance of each of the of the characters. This font is comprised of each photographic character derived from the set of aligned individual images of characters, both with and without a background. The font is saved to a computer storage media, including but not limited to a computer hard drive or a CD-ROM as shown in step 100 of FIG. 1. In one embodiment, the process is repeated for as many photographic font styles as the user desires. The fonts can be disseminated by a number of methods, including but not limited to a CD-ROM, floppy disk, ZipDisk, and the Internet as shown in step 1 10 of FIG. 1.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method of creation, modification, and storage of photographic fonts, said method comprising the steps of:
(a) perceiving at least one image at least partially comprising text;
(b) photographing said image with a photographic device onto a photographic media;
(c) transferring said image from said photographic device to computer memory in digital format;
(d) using software to isolate at least one individual image of a character from said text;
(e) using software to adjust each of said individual images of characters so that each said individual image has the same dimensions as the others; and
(f) saving said adjusted individual images as a font to a computer storage media.

2. The method described in claim 1, further comprising the step of using software to separate each of said individual images of characters from a background behind each of said individual images of characters.

3. The method described in claim 1, further comprising the step of using software to orient each of said individual images of characters so that the vertical axes of individual characters contained in said individual images of characters are parallel.

4. The method described in claim 1, further comprising the step of using software to adjust the color, brightness, and contrast of said individual images of characters.

5. The method described in claim 1, further comprising the step of using software to retouch said individual images of characters.

6. The method described in claim 1, further comprising the step of disseminating of a plurality of said fonts using the Internet.

7. A method according to claim 1, wherein said photographing is carried out using a digital camera.

8. A system for the creation, modification, and storage of photographic fonts, said system comprising the following:
(a) a photographic device for perceiving at least one image at least partially comprising text;
(b) a photographic device for photographing said image onto a photographic media;
(c) a device for transferring said image from said photographic device to computer memory in digital format;
(d) a computerized device for using software to isolate at least one individual image of a character from said text;
(e) a computerized device for using software to adjust each of said individual images of characters so that each said individual image has the same dimensions as the others; and
(f) a computerized device for saving said adjusted individual images as a font to a computer storage media.

9. The system described in claim 8, further comprising a computerized device for using software to separate each of said individual images of characters from a background behind each of said individual images of characters.

10. The system described in claim 8, further comprising a computerized device for using software to orient each of said individual images of characters so that the vertical axes of individual characters contained in said individual images of characters are parallel.

11. The system described in claim 8, further comprising a computerized device for using software to adjust the color, brightness, and contrast of said individual images of characters.

12. The system described in claim 8, further comprising a computerized device for using software to retouch said individual images of characters.

13. The system described in claim 8, further comprising a computerized device to disseminate a plurality of said fonts using the Internet.

14. A system according to claim 8, wherein said photographic device is a digital camera.
